(19) United States
(12) Patent Application Publication
(10) Pub. No.: US 2026/0041276 A1
(43) Pub. Date: Feb. 12, 2026

(54) FIREPLACE GRILL SYSTEM

(71) Applicant: Mark Allen, Newton, IA (US)

(72) Inventor: Mark Allen, Newton, IA (US)

(21) Appl. No.: 19/290,456

(22) Filed: Aug. 5, 2025

Related U.S. Application Data
(60) Provisional application No. 63/680,721, filed on Aug. 8, 2024.

(51) Int. Cl. A47J 37/07; A47J 33/00; F24C 15/08

(52) U.S. Cl. CPC A47J 37/0772; A47J 33/00; F24C 15/08

(57) ABSTRACT

A fireplace grill system having a hollow cabinet with a bottom wall, side walls, a front wall and back wall, and an open top. An opening in the front wall extends from the bottom wall to a termination point short of the open top. A plurality of support legs extend downwardly and away from the bottom wall.

### CROSS REFERENCE TO RELATED APPLICATION

This application claims the benefit of U.S. Application No. 63/680,721 filed Aug. 8 , 2024, the contents of these applications are hereby incorporated by reference in their entirety.

### BACKGROUND OF THE INVENTION

The present invention relates to the field of outdoor heating and cooking appliances, specifically to a combination outdoor fireplace and grill that provides an efficient and convenient solution for outdoor heating and cooking.

Outdoor fireplaces have become increasingly popular, offering a cozy gathering place and a source of warmth for outdoor spaces. These fireplaces are typically designed to enhance the aesthetic appeal of patios, decks, and gardens, providing both heat and ambiance. Separately, outdoor grills are widely used for cooking a variety of foods, offering an open flame or heat source that is ideal for grilling meats, vegetables, and other items.

Despite the popularity of both outdoor fireplaces and grills, their separation poses several challenges. Firstly, maintaining two separate installations can be cumbersome and requires considerable space. For those with limited outdoor space, having both an outdoor fireplace and a grill can lead to overcrowding and inefficient use of available area. Secondly, there is a duplication of effort and expense in purchasing, installing, and maintaining two separate units. Additionally, users often find it inconvenient to manage two different appliances when they could benefit from an integrated solution.

Efforts to combine these functions in the past have not been entirely successful. Existing products either compromise the heating efficiency of the fireplace or the cooking performance of the grill. Moreover, safety concerns and regulatory compliance issues have further complicated the development of a practical combined outdoor fireplace and grill system.

There is a need for an innovative appliance that integrates the functions of an outdoor fireplace and a grill, allowing users to enjoy the warmth and ambiance of a fireplace while also having the capability to cook food outdoors. This integrated system should address space efficiency, cost-effectiveness, and safety concerns while providing optimal performance for both heating and cooking.

The present invention addresses these issues by introducing a novel combination outdoor fireplace and grill system. This integrated appliance is designed to function seamlessly as both a heating source and a cooking grill, providing a practical and efficient solution for outdoor use. The invention features a robust design that ensures effective heating while incorporating a specialized cooking section that allows for efficient grilling of food.

An objective of the present invention is to provide a system having a dual-functionality design that operates efficiently as both a traditional outdoor fireplace and a high-performance grill, allowing users to switch between functions with ease.

Another objective of the present invention is to provide a system that conserves space and cost efficiency by combining two appliances into one, reducing the need for separate installations, saving space and reducing costs.

These and other objectives will be apparent to one skilled in the art based on the following written description and drawings.

### SUMMARY OF THE INVENTION

A fireplace grill system includes a hollow cabinet having a bottom wall, side walls, a front wall and back wall, and an open top. An opening in the front wall extends from the bottom wall to a termination point short of the open top. Extending downwardly and away from the bottom wall are a plurality of legs. The plurality of support legs are in one example positioned at the corners of the bottom wall where the side walls meet the front wall and the back wall. The support legs may also have wheels attached. Extending upwardly from a front edge of the bottom wall is a lip.

Extending partially over the open top is a ledge. The ledge extends inwardly and generally perpendicularly away from the side walls, front wall, and back wall at the open top. One or more grates are configured to be received upon and supported by the ledge and extend across at least a portion of the open top.

Additionally, or alternatively, one or more covers are configured to fit over the open top to at least partially enclose the open top. The cover has at least one handle. Also, the cover has one or more vents.

Attached to the cabinet is one more compartments. The compartments have a top wall, a bottom wall, a back wall, and a door configured to move from a closed to an open position. The compartments also have interior walls that form sub compartments.

One or more ledges also extend inwardly from the side walls and back wall within the hollow cabinet and are positioned to be accessed through the opening in the front wall.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a front plan view of a fireplace grill system;

FIG. 2 is a perspective view of the top of a fireplace grill system; and

FIG. 3 is a side view of a cover for a fireplace grill system.

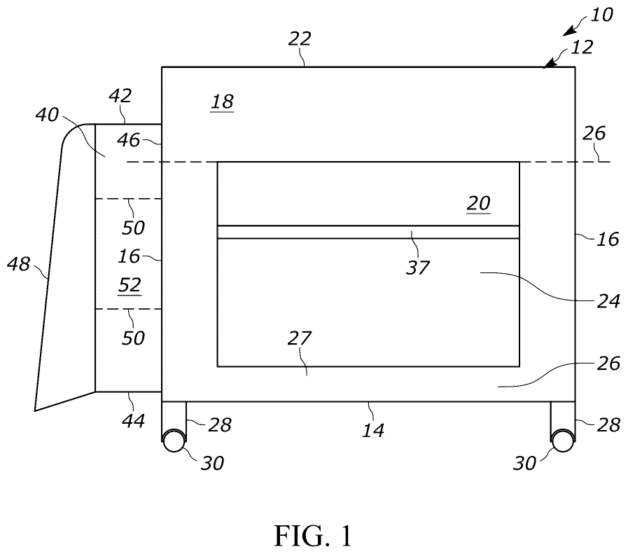

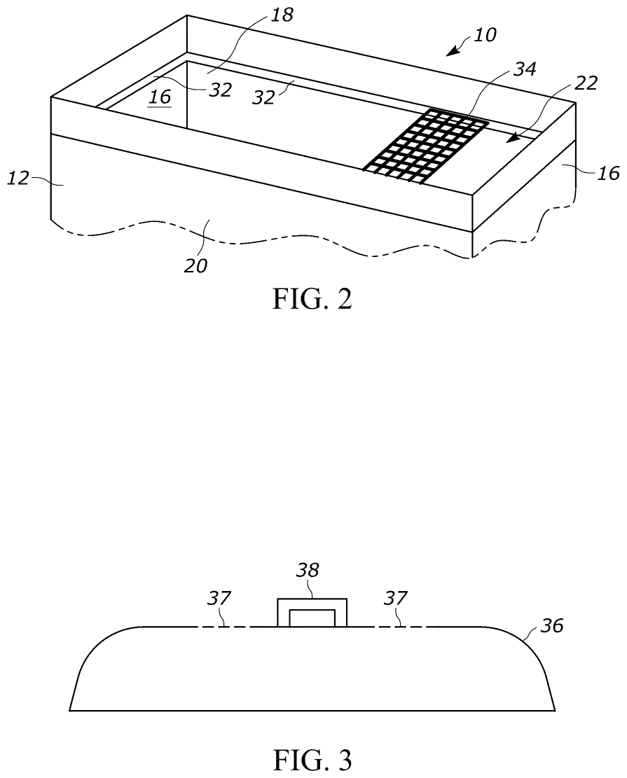

### DETAILED DESCRIPTION

Referring to the Figures the fireplace grill system 10 includes a hollow cabinet 12 with a bottom wall 14, side walls 16, a front wall 18, a back wall 20, and an open top 22. The front wall 18 has an opening 24 that extends from the bottom wall 14 to a termination point 26 short of the open top 22. Extending upwardly from a front edge 25 of the bottom wall 14 is a lip 27 that prevents a fuel source such as firewood from rolling out of opening 24.

Attached to the bottom wall 14 and extending downwardly and away from the bottom wall are a plurality of supports or legs 28. In the example shown the supports 28 are positioned at the corners of the bottom wall 14 where the side walls 16 meet the front wall 18 and the back wall 20. In an alternative example, the supports 28 have wheels 30.

Extending inwardly and generally perpendicularly away from the side walls 16, front wall 18, and back wall 20 at the open top 22 is a ledge 32 which extends partially over the open top 22. One or more grates 34 are configured to extend across the open top 22 and are supported by the ledge 32. Also, one or more covers 36 are configured to fit over the open top 22 to partially or completely enclose the open top. The covers 36 are supported by the ledge 32 and in one example have a handle 38. The covers 36 have one or more vents 37 to draw air upwardly from within the cabinet 12.

Additionally, or alternatively, one or more ledges 32 extend inwardly in parallel spaced relation from the side walls 16, and back wall within the hollow cabinet 12. The ledges permit one or more grates to be placed at different heights within the cabinet and accessed through the opening 24.

Attached to the cabinet 12 are one or more compartments 40. In the example shown, the compartments are attached to the side walls 16. The compartments 40 have a top wall 42, a bottom wall 44, a back wall 46, and a door 48 configured to move from a closed to an open position. Alternatively, the compartments 40 have interior walls 50 to form sub compartments 52. The compartments 40 are used to store cooking equipment and utensils. In one example, a compartment 40 is used to hold a cooling material 54 such as ice to store perishable items such as meat.

In operation, a fire source such as wood is inserted through the opening 24 in the front wall 18 and ignited. Heat and smoke will rise from the fire source through the cabinet 12 to the open top 22 and into the atmosphere. At this point the system 10 provides a cozy gathering place and a source of warmth for an outdoor space. To cook food, the grates 34 are placed on the ledge 32 and food items placed on the grate to be cooked. To direct the heat within the cabinet through the open top 22, one or more covers 36 are placed over the open top 22. For storage, or during non-use, the covers 36 are placed over the open top 22 to enclose.

Accordingly, a fireplace grill system has been disclosed that at the very least meets all the stated objectives.

From the above discussion and accompanying figures and claims it will be appreciated that the fireplace grill system 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A fireplace grill system, comprising:
a hollow cabinet having a bottom wall, side walls, a front wall, a back wall, and an open top;
an opening in the front wall that extends from the bottom wall to a termination point short of the open top;
a plurality of support legs extending downwardly and away from the bottom wall.

2. The system of claim 1 wherein the plurality of support legs are positioned at the corners of the bottom wall where the side walls meet the front wall and the back wall.

3. The system of claim 2 wherein the plurality of support legs have wheels.

4. The system of claim 1 wherein a ledge extends at least partially over the open top.

5. The system of claim 4 wherein the ledge extends inwardly and generally perpendicularly away from the side walls, front wall, and back wall at the open top.

6. The system of claim 1 wherein one or more grates are configured to extend across the open top and are supported by a ledge.

7. The system of claim 1 wherein one or more covers are configured to fit over the open top to at least partially enclose the open top.

8. The system of claim 7 where in the cover is supported by a ledge and has a handle.

9. The system of claim 1 wherein one or more compartments are attached to the cabinet.

10. The system of claim 9 wherein the compartments have a top wall, a bottom wall, a back wall, and a door configured to move from a closed to an open position.

11. The system of claim 10 wherein the compartments have interior walls that form sub compartments.

12. The system of claim 1 wherein a lip extends upwardly from a front edge of the bottom wall.

13. The system of claim 7 wherein the one or more covers have one or more vents.

14. The system of claim 1 wherein one or more ledges extend inwardly from the side walls and back wall within the hollow cabinet and are positioned to be accessed through the opening in the front wall.
